(19) United States
(12) Patent Application Publication
(10) Pub. No.: US 2026/0292002 A1
(43) Pub. Date: Sep. 24, 2026

(54) METHOD TO CONFIGURE AND OPERATE A LOCAL USER PLANE FUNCTION IN CUSTOMER PREMISE NETWORKS

(71) Applicant: InterDigital Patent Holdings, Inc., Wilmington, DE (US)

(72) Inventors: Antonio de la Oliva, Madrid (ES); Robert Gazda, Spring City, PA (US); Debashish Purkayastha, Eagleville, PA (US); Michael Starsinic, Newtown, PA (US)

(73) Assignee: InterDigital Patent Holdings, Inc., Wilmington, DE (US)

(21) Appl. No.: 19/476,991

(22) PCT Filed: Jun. 12, 2024
(86) PCT No.: PCT/US2024/033650

§ 371 Date: Oct. 20, 2025

Related U.S. Application Data
(60) Provisional application No. 63/507,753, filed on Jun. 13, 2023.

(51) Int. Cl. H04L 65/1069

(52) U.S. Cl. CPC H04L 65/1069

(57) ABSTRACT

A wireless transmit/receive unit (WTRU) may comprise a processor that is configured to receive a PDU session establishment request from a WTRU within a CPN. The processor may be configured forward the PDU session establishment request message via an established PDU session of a gateway associated with the CPN. The processor may be configured to receive, from a SMF, a L-UPF associated with the CPN based on at least one of the PDU session establishment request message or one or more capabilities associated with the gateway. The processor may be configured to establish a session between the WTRU and the L-UPF through the established PDU session.

### CROSS-REFERENCE TO RELATED APPLICATIONS

This application claims the benefit of U.S. Provisional Patent Application No. 63/507,753 filed on Jun. 13, 2023, the entire contents of which are incorporated herein by reference.

### BACKGROUND

In a 5G system (5GS), the user plane function (UPF) is the core network functional entity that interconnects the 5G-RAN with data networks (DNS) via the N6 reference point. The UPF is configured by the session management function (SMF) via the N4 reference point. In a customer premise network (CPN), the evolved residential gateway (eRG) connects to the 5G core network (5GC) as a WTRU via the 5G radio access network (5G-RAN). A CPN may need to route user plane traffic within a local on-premises DN (Local DN) while simultaneously routing traffic with DNs connected via the 5GS (outside of the CPN). A Local UPF function is needed within the CPN to handle Local DN traffic without routing it to the 5GC. However, the 5G system architecture does not support the deployment of a Local UPF in the CPN collocated with the eRG.

An example deployment of a Local UPF in the CPN collocated with the eRG is disclosed. An example eRG architecture that integrates a local UPF capable of utilizing the Local DN (through the L-UPF) and the 5G-RAN simultaneously for DNs outside the CPN via the 5GC is disclosed.

A CPN also requires that the signaling to control the overall eRG operation is under the direct control of the 5GC. This requirement imposes that the N2 and N4 interfaces must be carried on top of the connection between the WTRU in the eRG and the 5GC. Accordingly, the present disclosure provides example solutions for requisite CPN implementations given this requirement.

### SUMMARY

Methods and apparatuses are provided for an architecture of an eRG that may support a local customer premise network (CPN) user plane function (UPF) (L-UPF) via an N3 termination function (N3TF). For example, an N3TF may terminate an N3 interface in an eRG towards an L-UPF while performing an N2 signaling towards a 5G core network (5GC) access and mobility management function (AMF) and session management function (SMF). Methods and apparatuses are provided for an N2 interface of the N3TF that may be transported within a packet data unit (PDU) session established between an eRG and 5GC. Methods and apparatuses are provided for a procedure for a control plane setup for nodes within a CPN when the control plane uses an eRG established PDU session as a transport for control plane signaling. Methods and apparatuses are provided for a PDU session setup procedure for a WTRU connected to a premise radio access station (PRAS) in a CPN using an L-UPF. Methods and apparatuses are provided for NAS protocol extensions to request IP addresses to be assigned to devices/functions within the CPN connecting through a PDU session established by another device (e.g., the L-UPF connected through the eRG. Methods and apparatuses are provided for an eRG to use NAT to transport an N4 protocol (or any other protocol using IP).

A first wireless transmit/receive unit (WTRU) may include a processor and memory. The processor and memory may be configured to receive a packet data unit (PDU) session establishment request from a second WTRU within a customer premise network (CPN). The first WTRU may forward the PDU session establishment request message via an established PDU session of a gateway associated with the CPN. The first WTRU may further receive, from a session management function (SMF), a local user plane function (L-UPF) associated with the CPN based on at least one of: the PDU session establishment request message, or one or more capabilities associated with the gateway. The first WTRU may establish a session between the wireless transmit/receive unit (WTRU) and the L-UPF through the established PDU session.

In an example, the first WTRU may establish the PDU session with a user plane function (UPF) associated with a residential gateway (RG). Control plane data received from the first WTRU via an N2 interface may be forwarded via the established PDU session.

In one embodiment, control plane data received from the L-UPF via an N4 interface may be forwarded via the established PDU session.

Moreover, the L-UPF may be selected based on information provided by a WTRU premise radio access station (PRAS) in the PDU session establishment request message.

The information provided by the WTRU PRAS may include an indication of an L-UPF support, or information on a locality of a user.

The CPN may be a network located within a premise via the eRG, and the gateway may be an evolved residential gateway (eRG) that is connected to a core network via a mobile access network.

The first WTRU may further receive uplink data via the L-UPF from the second WTRU, and send the uplink data to the SMF via the gateway associated with the CPN.

In another example, the first WTRU may receive downlink data and send the downlink data to the second WTRU via the L-UPF. The PDU session establishment request message may be forwarded to an access and mobility management function (AMF).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example architecture for a customer premise network (CPN).

FIG. 3 is a system diagram illustrating an example architecture of a 5G system.

FIG. 4 is a diagram illustrating an example of a user plane protocol stack for a WTRU connected to a 5G access network.

FIG. 5 is a diagram illustrating an example of a control plane protocol stack between the WTRU and the 5G core network.

FIG. 6A is a system diagram illustrating an example architecture for an L-UPF deployment within an eRG.

FIG. 6B is a diagram illustrating example control plane paths for different connectivity options for the WTRU types within the CPN.

FIG. 6C is a diagram illustrating example data plane paths for different connectivity options for the WTRU types within the CPN.

FIG. 7A is a diagram illustrating an example of control plane paths for different WTRUs in a CPN.

FIG. 7B is a diagram illustrating an example of control plane paths for different WTRUs in a CPN.

FIG. 8 is a flowchart for an example procedure for setup of different control plane options for a CPN.

FIG. 9 is a flowchart for an example procedure to set up a PDU session for a WTRU connected to a PRAS using the L-UPF.

FIG. 10 is a table of examples of extended 5GSM capabilities IE.

FIG. 11 is a table of examples of extended PDU session establishment request message content.

FIG. 12 is a diagram illustrating an example of a control plane protocol stack for N4.

FIG. 13 is a flowchart for an example of N4 transport through a WTRU_{RG} PDU session with NAT.

### DETAILED DESCRIPTION

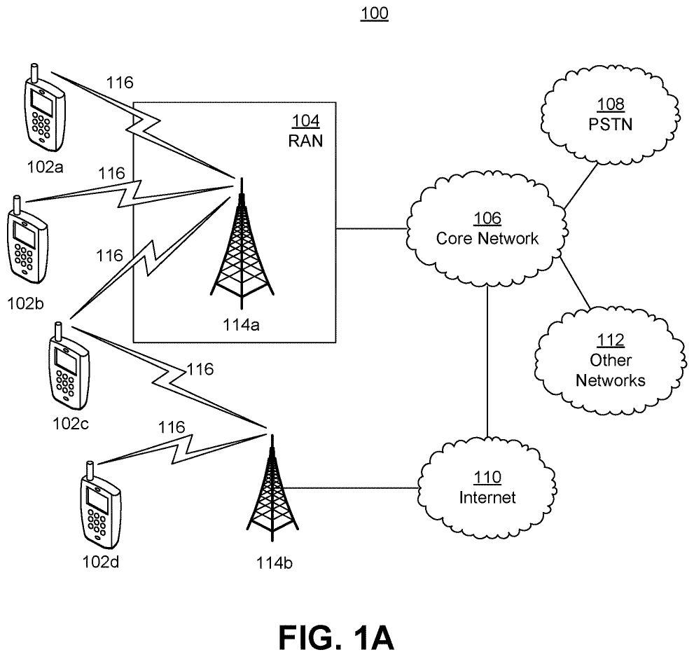

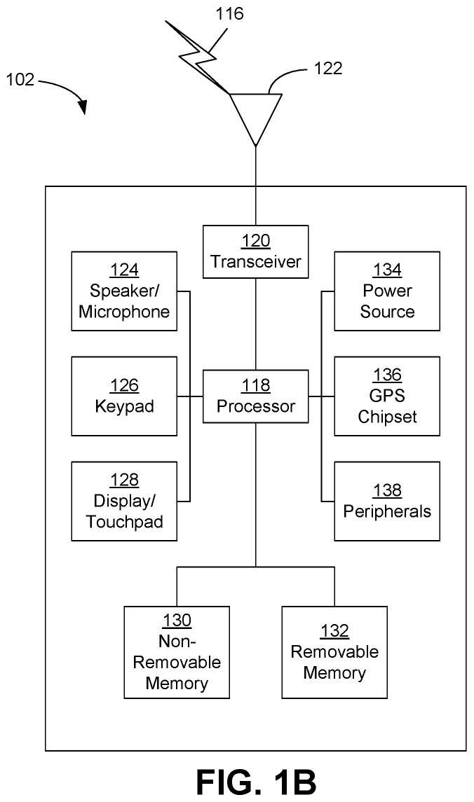

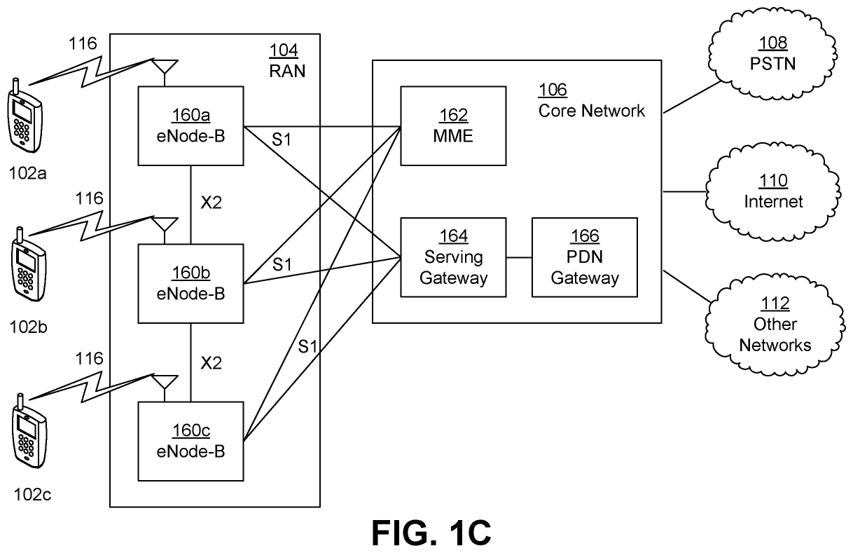

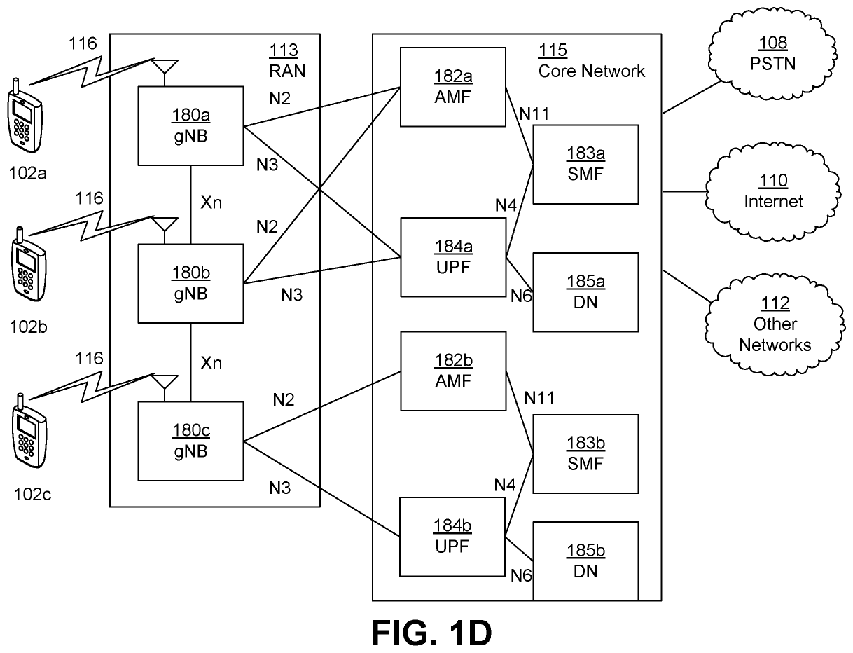

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or an “STA,” may be configured to transmit and/or receive wireless signals and may include a wireless transmit/receive unit (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed, or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP), and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to or receive signals from a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to and may receive user input data from the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from and store data in any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from and store data in memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor, a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP, and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operation, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped onto the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities, including support for (e.g., only support for) certain and/or limited bandwidths. The MTC devices may include a battery with a battery life above a threshold (e.g., to maintain a very long battery life).

WLAN systems, which may support multiple channels and channel bandwidths, such as 802.11n, 802.11ac, 802.11af, and 802.11ah, include a channel that may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to an STA (which supports only a 1 MHz operating mode) transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on the unlicensed spectrum, while the remaining component carriers may be on the licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c, and one or more eNode-Bs 160a, 160b, 160c substantially simultaneously. In the non-standalone configuration, eNode-Bs 160a, 160b, 160c may serve as a mobility anchor for WTRUs 102a, 102b, 102c, and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases, such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP addresses, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Customer Premises Networks (CPNs) are a kind of 3GPP network which may offer 5G connectivity and services and access within a premise setting (e.g., a home, an enterprise, an office, or shop). CPNs may be described as an evolution of the 5G-Residential Gateway concept, where a residential base station (e.g., such as a Premise Radio Access Station, PRAS) and an evolved Residential Gateway (eRG) are deployed with non-3GPP devices. CPNs may offer 5G connectivity within the premise-providing eMBB, URLLC, etc. via the PRAS (residential base station). This connectivity may bring E2E 5G QoS management of connected devices in the CPN. CPNs may offer 5G QoS maintenance from outdoor to indoor and vice versa mobility, efficient routing between PRAS connected WTRUs (WTRU to WTRU) and non-3GPP devices in the CPN—with QoS management, 5G LAN capability in the premise. CPNs may enable local CPN deployment of AF/Application Services on the premise—with 5G connectivity/QoS management with devices in the CPN.

Customer Premises Networks (CPNs) may be networks located in a customer premise and may use an enhanced Residential Gateway (eRG) to access connectivity and services provided by the 3GPP network. The eRG may be the evolution of the 5G Residential Gateway concept, connecting the CPN devices to the 3GPP network via a local WTRU. CPN's WTRUs may use a residential base station (e.g., such as a Premise Radio Access Station, PRAS) connected to the eRG to gain connectivity to the 3GPP services. CPN devices may use the eRG to gain connectivity services. Some CPN devices may be non-3GPP devices.

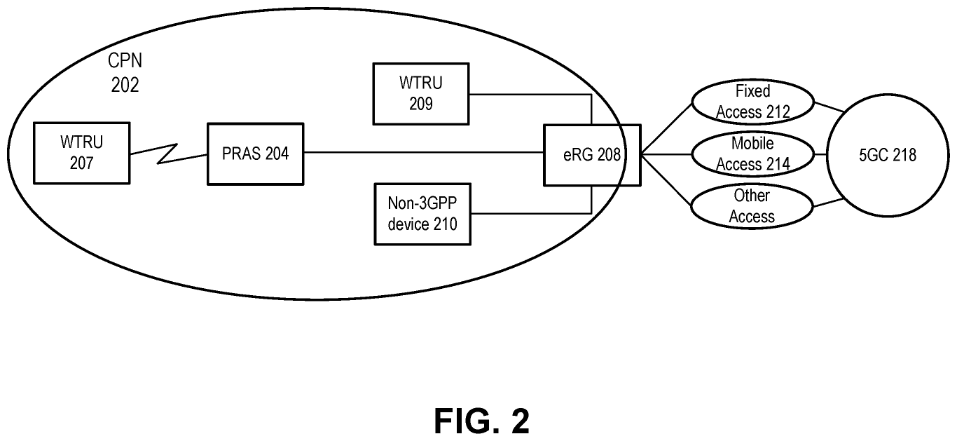

FIG. 2 is a system diagram illustrating an example architecture for a customer premise network (CPN) 202. The evolved residential gateway (eRG) 208 may play a role in the CPN 202 architecture as the element connecting each of the different devices in the CPN 202 (e.g., a WTRU 209 that is configured for 3GPP communications and non-3GPP configured devices 210) to the 5GS. Non-3GPP configured devices 210 may include an access point (IEEE 802.11) or a networked hard disk (ethernet). The non-3GPP configured devices may use the eRG 208 to gain connectivity The eRG 208 may be connected through different mechanisms to the 5GC 218 or a core network, including 5G Mobile Access 214 (e.g., 5G-RAN) or Fixed Access 212 (e.g., including using both mobile and fixed access together). The Fixed Access 212 may use radio waves to send high-speed signals that offer data transfer to and from consumer devices. Fixed access may enable fixed broadband access using radio frequencies instead of cables, and may be used to connect homes and businesses to the internet. The eRG 208 may be considered a WTRU towards the 5GC 218, regardless of whether the eRG 208 is connecting through mobile access 214 (e.g., 5G-RAN) or Fixed Access 212.

A differentiating factor regarding CPNs may be their ownership and administration. An end-user or other 3^{rd} party entity operating a WTRU 207 or any other entities (e.g., enterprise, building owner, landlord, or other 3^{rd} party provider) may be authorized to partially configure and/or manage a network node in a CPN (e.g., a PRAS 204, an eRG 208, and connected devices), as an Authorized Administrator through the WTRU 207 or any other entities. A CPN may be owned, installed, and/or (e.g., at least partially) configured by the customer (e.g., end-user or other 3^{rd} party) of a public network operator (MNO).

A set of requirements from a service perspective for a CPN connected to a 5G system may include any combination of the elements described herein. The 5G system may support IP traffic offload within the CPN.

The 5G system may provide an operator-controlled mechanism to enable the PRAS radio interface to be deactivated. For example, when the CPN has lost connectivity with the 5G network, the 5G system may provide an operator-controlled mechanism to enable, in the default configuration or under certain conditions configured by the operator, the PRAS radio interface to be deactivated. Furthermore, under certain other conditions configured by the operator, the CPN may be enabled to continue the existing intra-CPN communication as long as no interaction with the 5G network is needed (e.g., refreshing security keys).

The 5G system may support an efficient user plane path. For example, based on operator policy, application needs, or both, the 5G system may support an efficient user plane path, modifying the path as needed when the WTRU moves or an application changes location between a WTRU in an active communication and an application in a Service Hosting Environment, an application server located outside the operator's network, or an application server located in a customer premises network.

The 5G system may support real time end-to-end quality of service (E2E QoS) monitoring and control for any intra-CPN data traffic to or from a WTRU (e.g., via eRG or via PRAS and eRG).

The 5G system may support real time E2E QoS monitoring and control for any data traffic between a WTRU within a CPN and the 5G network (e.g., via eRG or via PRAS and eRG).

The 5G system may support charging data collection and lawful interception (LI) for data traffic to/from individual WTRUs in a CPN (e.g., WTRUs behind the eRG and/or PRAS).

The 5G system may generate charging data that can differentiate between backhaul for the PRAS and other data traffic over the same access.

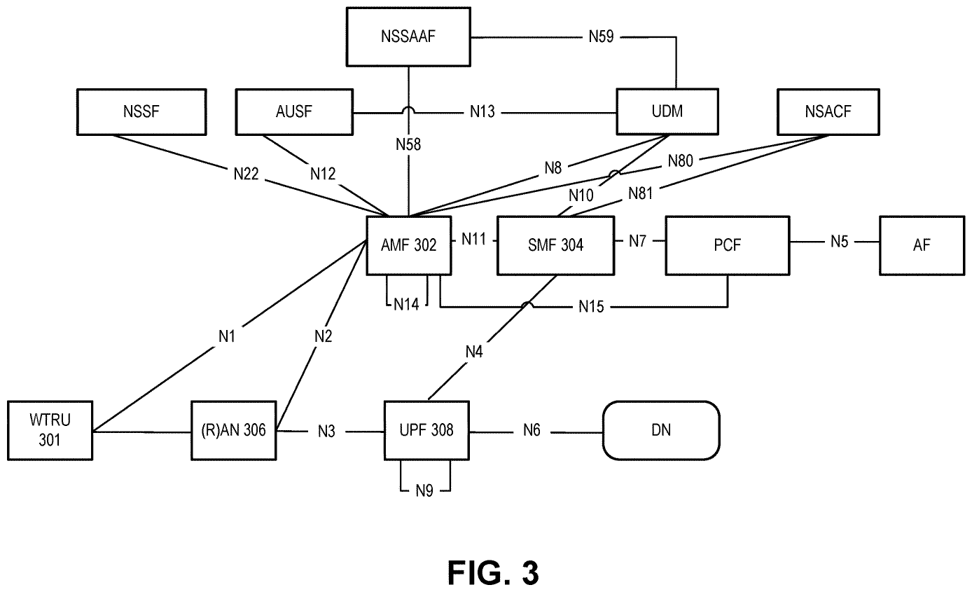

FIG. 3 is a system diagram illustrating an example architecture of a 5G system. The example architecture may define different interfaces of the 5G system. The N1 interface may be the control plane interface that a WTRU 301 may communicate with AMF 302, whose messages are delivered via the N2 interfaces through the gNB. An N1 NAS signaling connection may be the concatenation of a radio resource configuration (RRC) connection via the Uu reference point and a next generation (NG) connection via the N2 reference point for 3GPP access. An N1 NAS signaling connection may be the concatenation of an IPsec tunnel via the NWu reference point and an NG connection via the N2 reference point for non-3GPP access. The N1 interface may transport the NAS protocol for mobility management functionality (NAS-MM) support registration management functionality, connection management functionality, and/or user plane connection activation and deactivation. The N1 interface may be responsible for ciphering and integrity protection of NAS signaling.

The N4 interface may be the interface between the control and user planes for UPF 308 and SMF 304. The N4 interface may be implemented through the packet forwarding control protocol (PFCP).

The N3 interface may be the interface between the RAN 306 and the UPF 308. The N3 interface may carry user plane data in the form of a GPRS Tunnelling Protocol User Plane (GTP-U) tunnel.

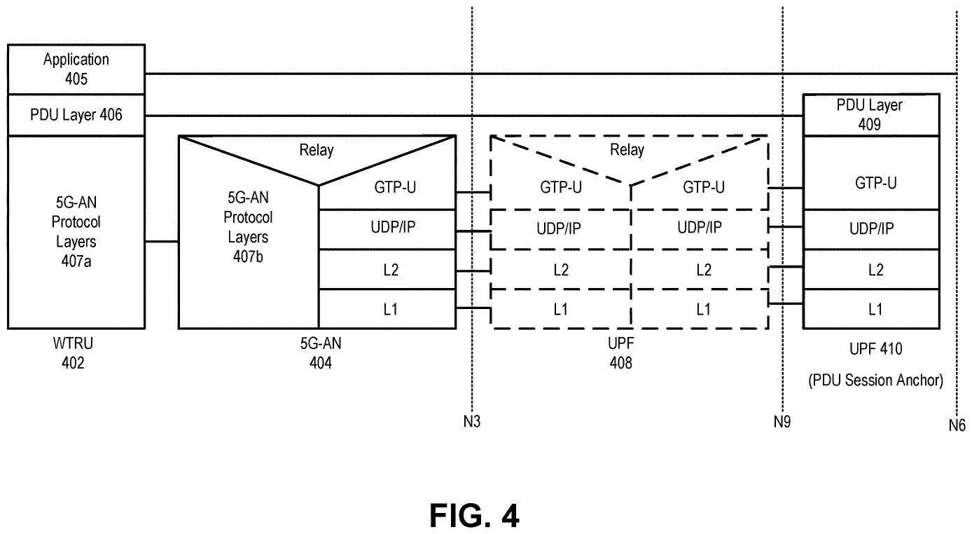

FIG. 4 is a diagram illustrating an example of a user plane protocol stack for a WTRU 402 connected to a 5G access network (AN) 404. Traffic from an application located in an application layer 405 at the WTRU 402 may be encapsulated by the PDU layer 406 and sent through the 5G-AN protocol layers 407a, 407b at the WTRU 402 and the 5G-AN 404 to the UPF 410. The interactions along WTRU 402, 5G-AN 404, UPF 408 and UPF 410 may depend on layers of protocol stack. At the control plane, the WTRU 402 may not interact with the UPF 410 directly. For example, the 5G-AN protocol layer 407a in WTRU 402 may not interact with UPF 410 directly. The 5G-AN protocol layer 407a in WTRU 402 may interact with 5G-AN 404. At the data plane, the PDU layer 406 may interact with the corresponding PDU layer 409 of UPF 410 directly. The 5G-AN 404 may be in charge of terminating the interfaces to the WTRU and encapsulating the user traffic in a GTP tunnel to the UPF 410 (e.g., over the N3 interface). For example, the application generated traffic, encapsulated in a transport protocol such as UDP or TCP, may be included as payload of a GTP over UDP tunnel. The application generated traffic may be carried over an IP datagram, and may be encapsulated in a layer 2 frame (layer 2 header information may be encapsulated in GTP in case of an Ethernet or unstructured PDU session).

Relaying UPF 408 may be regarded as an intermediate UPF 408, which is in charge of perform forwarding, encapsulation and decapsulation of GTP tunnels. These intermediate UPFs are used as, e.g., UL CL/BPs (Uplink Classifiers/Branching points).

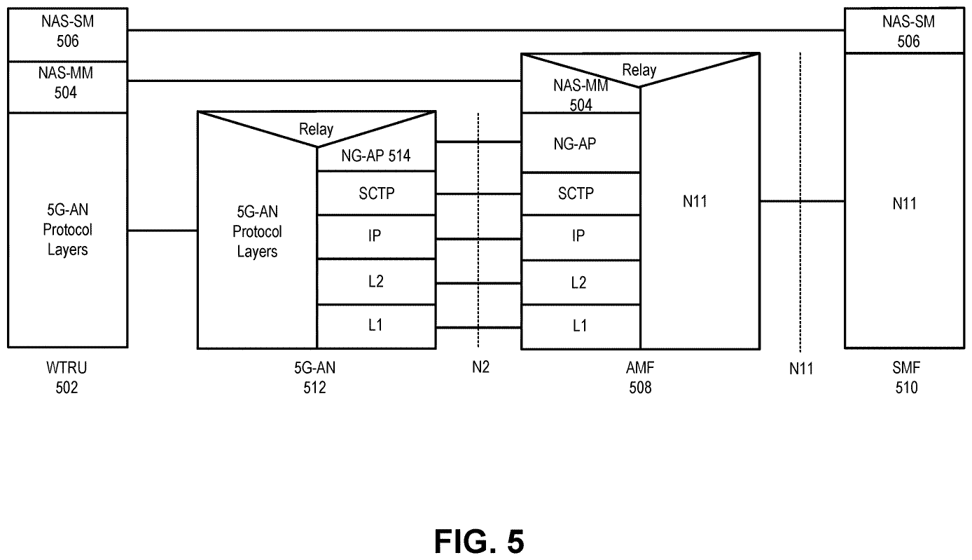

FIG. 5 is a diagram illustrating an example of a control plane protocol stack between the WTRU 502 and the 5G core network. The protocol used to convey information between the WTRU 502 and the 5GC may be the NAS (non-access stratum). The NAS protocol may be composed of multiple variants, such as the NAS-Mobility Management (NAS-MM) 504 and the NAS-Session Management (NAS-SM) 506. The NAS-MM 504 may be the protocol used between the AMF 508 and the WTRU 502. The NAS-SM 506 may correspond to the protocol used between the WTRU 502 and SMF 510.

The NAS protocol may be transported on top of the next generation interface application (NG-AP) protocol 514 once the NAS protocol reaches the 5G-AN 512 (e.g., encapsulated in the gNB and sent to the AMF 508) through the N2 interface. The N2 interface may make use of the NGAP protocol. The NGAP protocol may be encapsulated in SCTP (Stream Control Transport Protocol, RFC 4960) which in turn makes use of IP transport.

Examples are disclosed for connecting a WTRU internal to the eRG (providing a 5GC connection), and a Local UPF may be implemented for offloading, data path optimization, and supporting situations where there is a lack of 5G connectivity. The WTRU internal may be a component of the eRG that acts as a gateway to the 5GC.

Example embodiments are disclosed for terminating the N3 interface between the WTRU connecting the eRG to the 5G-RAN and the Local UPF.

Example embodiments are disclosed for managing N2 and N4 signaling between the Local UPF and 5GC. Transporting N2 and N4 between the Local UPF and the 5GC may be implemented to support offloading, data path optimization, supporting lack of connectivity, QoS, and charging data collection.

An example embodiment is disclosed for managing the connectivity of the L-UPF and other entities in the eRG when the 5GC provides the IP addresses used for the control plane.

Managing the connectivity of the entities within the eRG (including the L-UPF) may be needed to support each of the requirements described herein.

Described herein is an example architecture for the eRG supporting an L-UPF via an N3 Termination Function (N3TF). Also described herein is an example description of an N3TF, which may terminate the N3 interface in the eRG towards the L-UPF while performing the N2 signaling towards the AMF and SMF. Further, the present disclosure defines an example of how the N2 interface of the N3TF may be transported within the PDU session established between the WTRU_{RG} and 5GC. In an example, entities included in the 5GC may include an AMF, a SMF, and/or a UPF. The entities included in the 5GC may also include WTRU internal, a component of the eRG. The entities included in the 5GC may include a WTRU attached to a PRASS. The disclosure defines an example procedure for the control plane setup for nodes within the CPN when the control plane uses the eRG established PDU session as a transport for control plane signaling. Additionally, the disclosure defines an example PDU session setup for a WTRU connected to a PRAS using the L-UPF. Also defined are example extensions to the NAS protocol, such as extensions that provide for a request for addresses to be assigned to devices connecting through the PDU session established by another device (e.g., the L-UPF connected through the WTRU_{RG}). Further, the disclosure defines an example mechanism by which the WTRU_{RG} may use network address translation (NAT) to transport the N4 protocol (e.g., or any other protocol using IP).

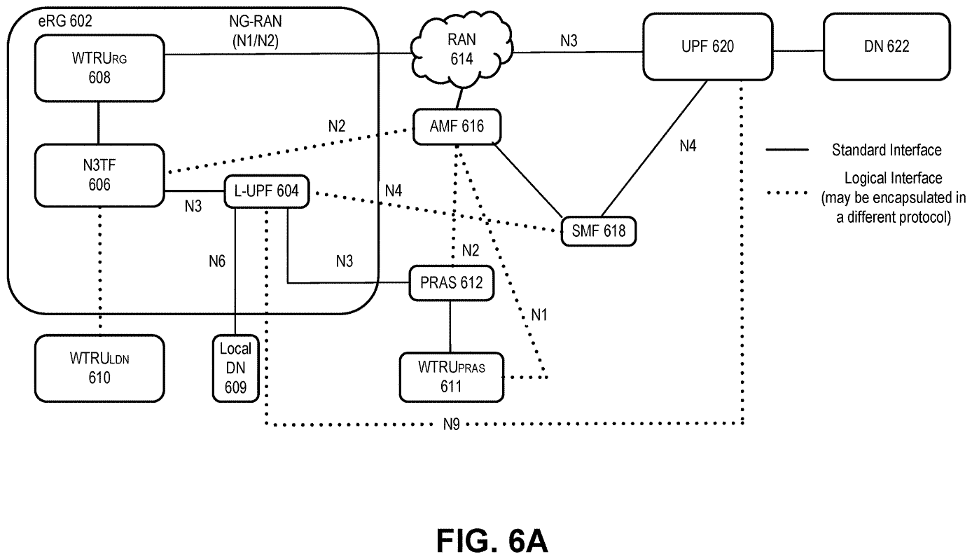

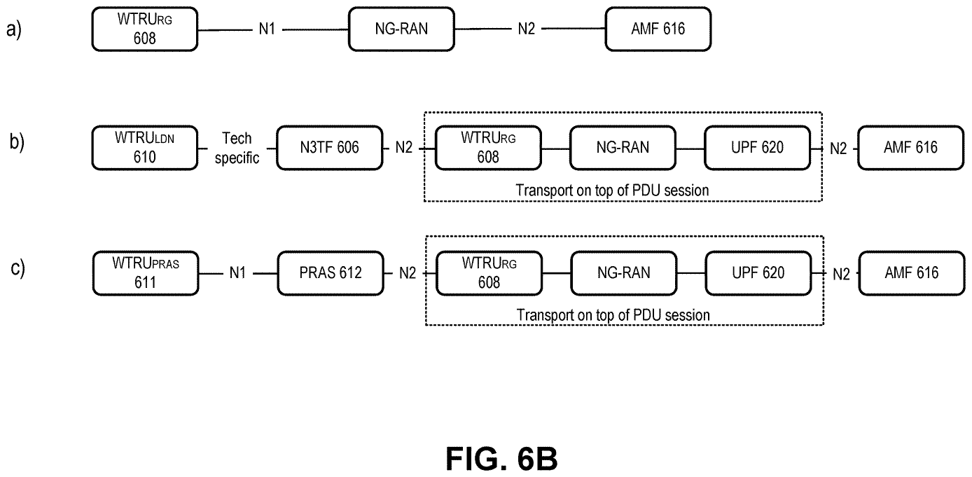

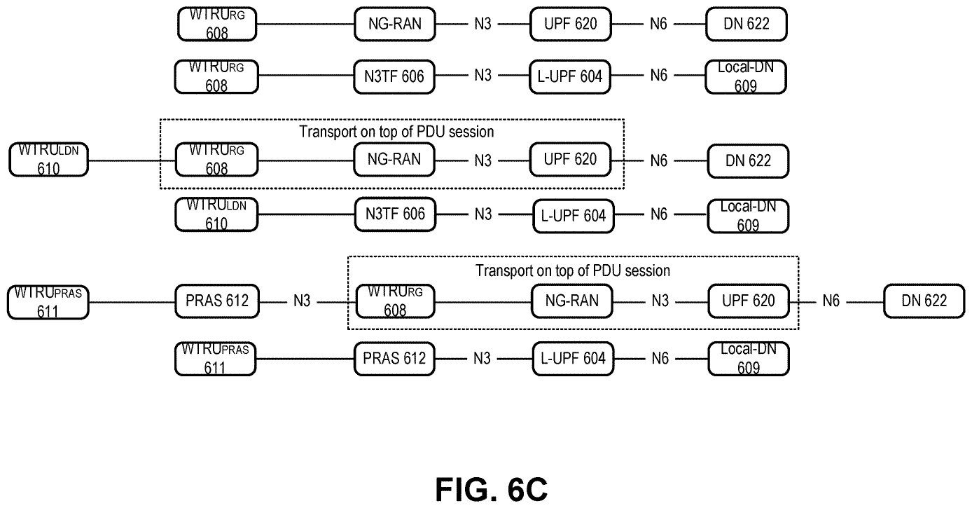

FIG. 6A is a system diagram illustrating an example architecture for an L-UPF 604 deployment within an eRG 602. The illustrated example architecture for the eRG 602 may support an L-UPF 604 via an N3 Termination Function (N3TF) 606. There may be a plurality (e.g., three) of different WTRU types with the CPN, each of the WTRU types connecting differently. The Access and Mobility Management Function (AMF) 616 may manage connections and handovers for mobile devices in a 3GPP network. The Session Management Function (SMF) 618 may handle data traffic routing and policy enforcement in the 3GPP Core Network. The User Plane Function (UPF) 620 may forward user data packets between the mobile device and the internet in the 5G Core Network.

WTRU_{PRAS} 611 and AMF 616 may communicate via N1 interface. The WTRU_{RG} 608 type may be that part of the eRG 602 that connects to the 5GC and behaves as a WTRU towards the 5GC-3GPP network. Thus, the WTRU_{RG} may have an already established connection with the 3GPP network through the (R)-AN 614. The WTRU_{RG} 608 may oversee sending the CPN/eRG user plane and control plane traffic to the 3GPP network. The WTRU_{RG} 608 may be configured such that the WTRU_{RG}'s user or control plane traffic cannot be offloaded to the L-UPF 604 and is desired to be sent to the 3GPP network.

The WTRU_{LDN} 610 type may correspond to a WTRU connected to the local data network 609 of the CPN, although not via a CPN PRAS 612. For example, the WTRU_{LDN} 610 may be a non-3GPP device connected via WiFi access or a 3GPP device connected to a home LAN in the client premises. The eRG 602 may connect to the 3GPP network and behave as a WTRU towards the 3GPP network. The WTRU_{LDN} 610 type and the WTRU_{PRAS} 611 type may leverage the eRG 602 pre-established connection with the 3GPP network to gain connectivity to the 3GPP network and in turn the DN 622. WTRU_{PRAS} 611 type, PRAS 612, Local DN 609, WTRU_{LDN} 610 type, and the eRG 602 may form a customer premise network (CPN). The CPN may be connected to a data network 622 via the 3GPP network. The eRG 602 may be connected to the 5GC via a mobile access network, fixed access network or other network. The RAN 614 may receive a packet data unit (PDU) session establishment request from the WTRU_{PRAS} 611 type, WTRU_{LDN} 610 type, and/or WTRU_{RG} 608 type. The WTRU_{PRAS} 611 type, WTRU_{LDN} 610 type, and/or WTRU_{RG} 608 type may be located within the CPN.

The WTRU_{PRAS} 611 type may correspond to a WTRU that connects to a PRAS 612 in the CPN. An interface may mean an interface as shown, as described, and/or as standardized. A logical interface may mean the communication and/or interface is transported on top of other interfaces or network segments. For example, in FIG. 6A, N2 may go between RAN 614 and AMF 616. As shown in FIG. 6A, N2 may be between N3TF 606 and AMF 616. N2 being between N3TF 606 and AMF 616 may indicate that this interface is the same as the interface specified in N2. But the end points may not be the same and N2 may be transported as a payload in data plane between the WTRU_{RG} 608 and UPF 620.

FIG. 6B is a diagram illustrating example control plane paths for different connectivity options for the WTRU types within the CPN. FIG. 6C is a diagram illustrating example data plane paths for different connectivity options for the WTRU types within the CPN.

FIG. 6B shows different ways of communication. A difference between how these WTRUs (e.g., the WTRU_{RG} 608, the WTRU_{LDN} 610, and the WTRU_{PRAS} 611) access the network may be the interface through which communications may be performed (e.g., whether to implement the N3 interface through the N3TF (N3 Termination Function) 606 when using the L-UPF 604. (as shown in FIG. 6A, or the data plane of FIG. 6C). The WTRU_{PRAS} 611 type may connect to a PRAS 612 which is a 5G RAN. Therefore, the PRAS 612 may terminate N3 and encapsulate the packets from the WTRU_{PRAS} type into a GTP tunnel between the PRAS 612 and the L-UPF 604. PRAS 612 may also send traffic to UPF 620 for DN 622. The L-UPF 604 may also work as a relay UPF with traffic routed via the eRG to the UPF 620 and the DN 622.

In some examples, the WTRU_{LDN} 610 type may not be connected to any 3GPP network entity which terminates the N3 interface. Therefore, the WTRU_{LDN} 610 may interact with the N3TF 606 to connect to a 3GPP network entity. Similar behavior may occur when there is a failure in the 5G-RAN or the WTRU_{RG} 608 type performs a local-breakout through the L-UPF 604, for example, as depicted in FIG. 6A.

When WTRUs use the connectivity of the WTRU_{RG} 608 type to transport their data or control packets, the WTRU may use its own already established PDU connection to transport these messages. The eRG 602 may connect to the 5GC and behave as a WTRU towards the 5GC. The WTRU_{LDN} 610 type and the WTRU_{PRAS} 611 type may leverage the eRG 602 or pre established connection with the 5GC to connect to RAN 614. WTRU_{PRAS} 611 type, PRAS 612, Local DN 609, WTRU_{LDN} 610 type, and the eRG 602 may form a customer premise network (CPN). The CPN may be connected to a network via the 5GC. The eRG 602 may be connected to the 5GC via a mobile access network. The RAN 614 may receive a packet data unit (PDU) session establishment request from the WTRU_{PRAS} 611 type, WTRU_{LDN} 610 type, and/or WTRU_{RG} 608 type. The WTRU_{PRAS} 611 type, WTRU_{LDN} 610 type, and/or WTRU_{RG} 608 type may be located within the CPN.

The example architecture for a customer premise network (CPN) may provide specific characteristics. These characteristics may include the eRG presenting itself to the 5GC as a WTRU, as required for a CPN. These characteristics may include that while the connection through the 5G-RAN is active, the signaling to control each of elements of the eRG/CPN is transmitted through the 5G-RAN. These characteristics may include that if the 5G-RAN connection is down, the eRG may use the local data network (DN) (e.g., through L-UPF 604) to connect to the 5GC if the local DN has an alternate non-3GPP connection (e.g., fixed access) to the 5GC. Lastly, these characteristics may include data traffic from WTRU_{PRAS} 611 and WTRU_{LDN} 610 type of WTRUs may be transmitted through the L-UPF 604 (Local CPN DN) or the WTRU_{RG} 608 type of WTRU (e.g., DN 622 via 5GC).

An N3 termination function (N3TF) 606 may be collocated with the eRG and may share the credentials of the eRG to establish a security association with the 5GC. The N3TF 606 may terminate the N3 interface in the eRG towards the L-UPF while performing the N2 signaling towards the AMF 616 and SMF.

The N3TF 606 may be defined as a function that terminates the N3 interface towards the L-UPF 604 while performing the N2 signaling towards the AMF 616 and SMF. For example, the N3TF 606 may perform such functionalities as terminating the N2 and N3 interfaces in the eRG. The N3TF 606 may implement the AMF 616 selection procedure. The N3TF 606 may transparently relay NAS messages for WTRUs using the L-UPF (WTRU_{LDN} 610 or WTRU_{RG} 608) between the WTRU and the AMF 616. The N3TF 606 may handle N2 signaling with SMF (relayed by AMF 616) for supporting PDU sessions and QoS. The N3TF may transparently relay PDU data units between WTRUs connected to the PRAS 612 or the Local DN and L-UPF 604. Lastly, the N3TF 606 may implement a local mobility anchor within the CPN.

The control level functionality of the N3TF 606 towards the core may be similar to the Non-3GPP Inter-Working Function (N3IWF) or TWNF functions. Differences between N3TF 606 and these functions may include the N3TF 606 control interfaces towards the 5GC may be transported over the data connection established by WTRU_{RG}. The N3TF 606 and WTRU_{RG} 608 may be collocated. This characteristic may enable the direct transport of information between the WTRU_{RG} 608 and the N3TF 606, in contrast to the N3IWF or TNGF, which may require an IPSec association. Lastly, the placement of the N3TF 606 within the eRG may enable the N3TF 606 to be used by the internal WTRU of the eRG (WTRU_{RG} 608) and the external WTRUs connected to the DN 622.

The WTRU_{LDN} type may use the functionality provided by the N3TF 606 to establish a PDU session between a WTRU_{LDN} 610 type WTRU and the 5GC. In this case, the N3TF 606 may behave like an N3IWF, a TNGF, or a non-5G-Capable over WLAN (N5CW).

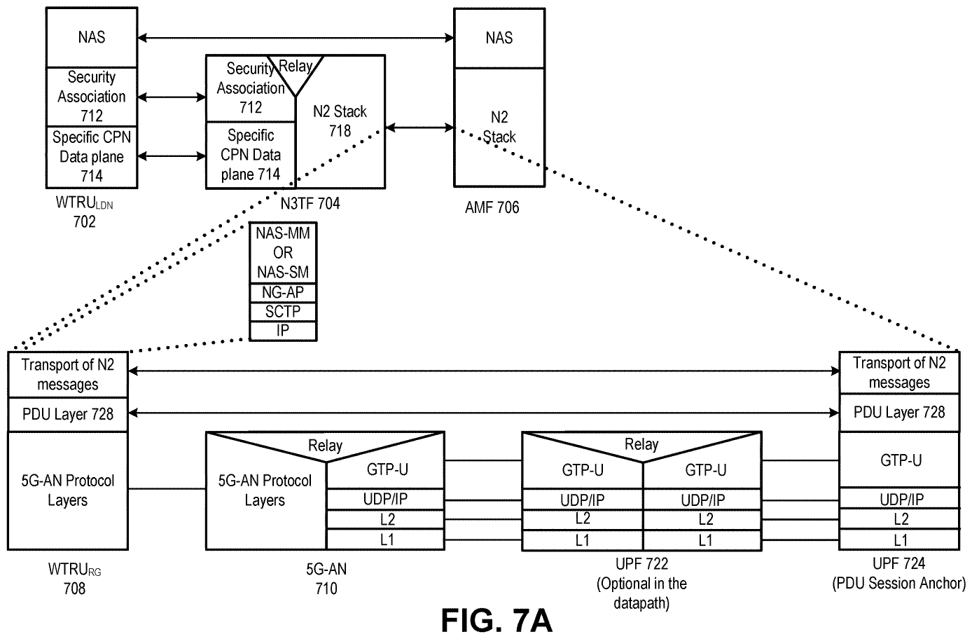

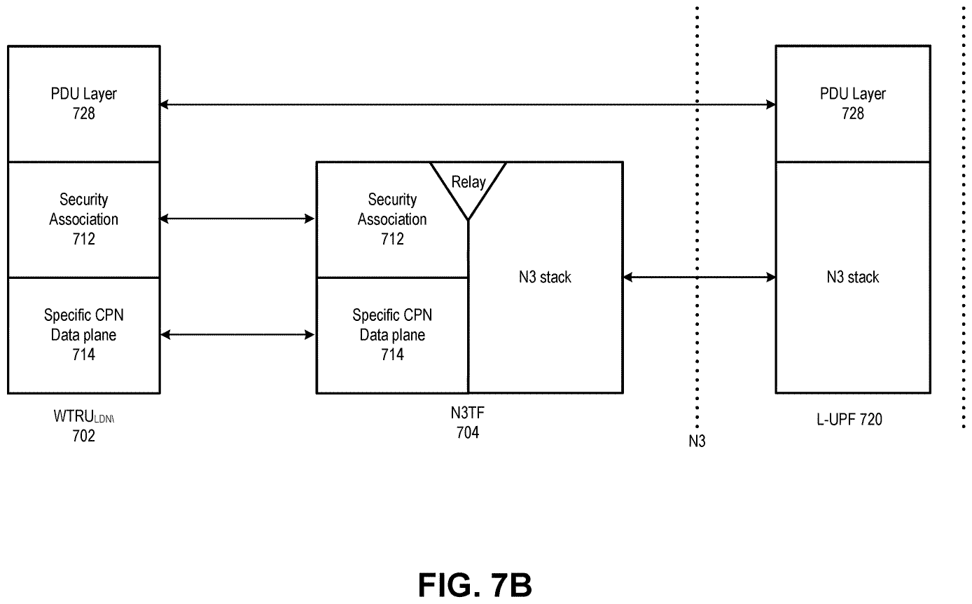

FIG. 7A is a diagram illustrating an example of control plane paths for different WTRUs in a CPN. FIG. 7B is a diagram illustrating an example of control plane paths for different WTRUs in a CPN. FIGS. 7A and 7B demonstrate examples of how the N2 interface of the N3TF may be transported within the PDU session established between the WTRU_{RG} and 5GC.

In FIG. 7A, a control plane path for WTRU_{LDN} 702 is disclosed. The WTRU_{LDN} 702, connected to the local DN at the Specific CPN Data plane 714, may establish a secure association 712 with the N3TF. This secure association may be a 5G-EAP based one, IPSec, or any other (e.g., including a non-security association) similar type of association known to a person of ordinary skill in the art. FIG. 7A illustrates a path of control plane, N2. As shown in FIG. 7A, the protocol stack of an N2 connection between the N3TF 704 and the AMF 706 manages the nodes connected to the N3TF 704. N2 may be transported on top of the PDU connection established by WTRU_{RG} 708. FIG. 7A shows the PDU connection of the WTRU_{RG} 708 and how N2 signaling may be transported from the N3TF 704 on top of the PDU Layer. The UPF 722 and UPF 724 may be the UPFs serving the WTRU_{RG} 708 to transport data packets from WTRU_{RG} 708.

The N3TF 704 may behave as an N2 termination point and exchange signaling with the AMF 706 and SMF through the N2 interface to establish a PDU session through the L-UPF or the WTRU_{RG} 608. The N2 Stack 718 may include NG-AP, SCTP, IP, L2, and L1. The N2 termination point may be a node that terminates an N2 connection, which may be gNBs, AMFs, N3IWF, etc. N2 packets may be packets according to an NG-AP protocol. The N2 interface may be a logical point-to-point interface, which will be transported through the data connection of the WTRU_{RG} 708 via the 5G-AN 710. Once the N2 packets are decapsulated by the PSA user plane function (UPF) 724 of the WTRU_{RG} 708 PDU session, the N2 packets may be sent to the AMF 706 indicated by the destination IP address of the packet.

As shown in FIG. 7B, after the PDU session has been established, data from the WTRU_{LDN} 702 may be forwarded to the L-UPF 720. FIG. 7B illustrates a data plane, N3 interface. FIG. 3, FIG. 6A, and FIG. 6C may illustrate control plane N3 interfaces.

Considering the PDU establishment for the WTRU_{RG} 708 and WTRU_{PRAS}, certain considerations may apply.

The WTRU_{RG} 708 and N3TF 704 may be collocated, which means that there may be no need to establish a security association 712 between the WTRU_{RG} 708 and the N3TF 704. Moreover, the establishment of a WTRU_{RG} 708 PDU session through the L-UPF 720 may follow the same protocol stack as disclosed in FIG. 7A, replacing WTRU_{LDN} 702 with WTRU_{RG} and the consideration of the security association may not be included. L-UPF 720 is a UPF inside the eRG.

The WTRU_{PRAS} may be connected to a PRAS, which is a gNB. The PRAS may be able to terminate the N2 interface, therefore the PRAS may not be desired to interact with the N3TF 704. To simplify and reduce the overhead of the PRAS, the PRAS may not terminate the N2 interface, the N3TF 704 may terminate the N2 interface.

Each of CPN signaling may be transmitted by default through the WTRU_{RG} 708 5G-RAN connection. The signaling disclosed in FIG. 7A may be valid for the scenario where the PRAS terminates the N2 interface by exchanging the N3TF 704 with the PRAS, as shown in FIG. 7A.

As shown in FIGS. 7A and 7B, the data plane of the WTRU_{RG} 708 may transport the N2 interface.

In an embodiment, the data plane of the WTRU_{RG} 708 may transport the N4 signaling. In the architecture disclosed in FIG. 6A, the L-UPF 604 may also connect through a logical point-to-point interface to the SMF, namely the N4. The signaling used to control the L-UPF 604 over N4 may be transported using the same mechanism defined in the clause, transporting N4 messages between the SMF and L-UPF 604 encapsulated in the PDU Layer 728.

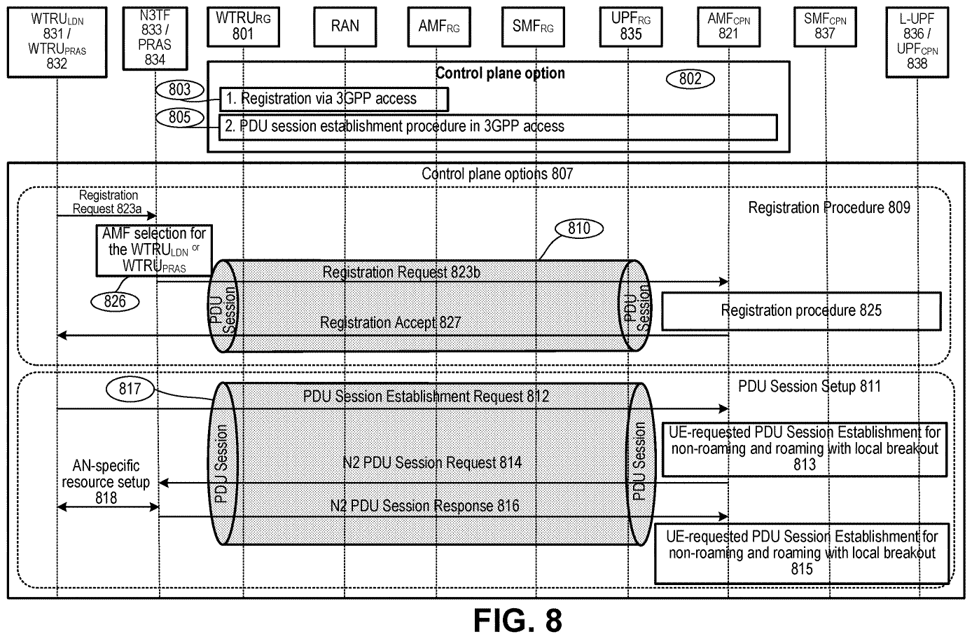

FIG. 8 is a flowchart for an example procedure for setup of different control plane options for a CPN. A procedure for the control plane setup for nodes within the CPN when the control plane uses the eRG established PDU session as a transport for control plane signaling is disclosed herein.

As described above, FIG. 6B discloses the different control plane paths that may be used. Options b) and c) in FIG. 6B use an already established PDU session by the WTRU_{RG} 608 to perform the different control procedures such as registration or PDU session establishment.

FIG. 8 discloses different procedures per the 3GPP standards when options b) and c) of FIG. 6B for the control plane are used. FIG. 8 discloses different AMFs, SMFs, and UPFs for the WTRU_{RG} and the WTRU_{LDN} Or WTRU_{PRAS}, although, in some deployments, they may be collocated or even be the same. FIG. 8 discloses that the SMF may decide to use the L-UPF for the data traffic of the different WTRUs connected in the CPN.

As shown in FIG. 8, the WTRU_{RG} 801 may register into the network and set up a PDU session. For example, the WTRU_{RG} 801 may register into the network and set up a PDU session as shown at 802 using a control plane option. For example, the control plane option shown at 802 may have a control plane path for different WTRUs in the CPN as shown in option a) in FIG. 6B.

Once the PDU session is configured, the WTRU_{LDN} 831 and/or WTRU_{PRAS} 832 may connect through either the N3TF 833 and/or PRAS 834, respectively, and perform a registration at 803 and a PDU session establishment at 805. A difference between this PDU session establishment 805 and another procedure may be that the different control messages are encapsulated through the PDU session previously established by the WTRU_{RG} 801. For example, the different control messages may be encapsulated through the PDU session previously established by the WTRU_{RG} 801 as shown at 807 using a control plane option. The control plane options shown at 807 may have a control plane path for the different WTRUs in the CPN as shown in options b) and c) in FIG. 6B.

Registration Procedure 809 illustrates a registration process. For example, the WTRU_{LDN} 831 and/or WTRU_{PRAS} 832 may transmit a registration request 823a to the N3TF 833 and/or PRAS 834. At 826, the N3TF 833 and/or PRAS 834 may perform an AMF selection for the WTRU_{LDN} 831 and/or WTRU_{PRAS} 832. A registration request 823b may be sent from the N3TF 833 and/or PRAS 834 to an AMF_{CPN} 821, a SMF_{CPN} 834, and/or a L-UPF through PDU session 810, where the L-UPF may be an L-UPF 836 and/or a UPF_{CPN} 838. The PDU session 810 may be a previously established PDU session. For example, the PDU session 810 may be a previously established PDU session between the WTRU_{RG} 801 and/or UPF_{RG} 835. A registration procedure may be performed at 825. For example, the registration procedure may be performed at 825 by the AMF_{CPN} 821, a SMF_{CPN} 837, the L-UPF 836 and/or a UPF_{CPN} 838. A registration accept message 827 may be sent from the AMF_{CPN} 821, a SMF_{CPN} 837, the L-UPF 836 and/or a UPF_{CPN} 838 to WTRU_{LDN} 831 and/or WTRU_{PRAS} 832 through PDU session 810.

A PDU session setup process may be performed at 811. For example, the PDU session setup process may be performed after the registration procedure 809. A PDU Session Establishment Request 812 may be sent from the WTRU_{LDN} 831 and/or WTRU_{PRAS} 832 to the AMF_{CPN} 821 through a PDU session 817. The PDU session 817 may be a previously established PDU session. For example, the PDU session 817 may be a previously established PDU session between the WTRU_{RG} 801 and/or UPF_{RG} 835. The PDU session 817 may be the same or different from the PDU session 810.

At 813, the AMF_{CPN} 821, a SMF_{CPN} 837, the L-UPF 836 and/or the UPF_{CPN} 838 may perform a UE-requested PDU Session Establishment for non-roaming and roaming with local breakout. For example, the UE-requested PDU Session Establishment for non-roaming and roaming with local breakout may include and/or correspond to the SMF selection, creation of PDU session SMF context, retrieval of information from the UDM, PDU session authentication/authorization, PCF selection, UPF selection, N4 session establishment and N1/N2 message transfer. An N2 PDU Session Request 814 may be sent from the AMF_{CPN} 821 to the N3TF 833 and/or PRAS 834 through the PDU session 817. An AN-specific resource setup 818 may be performed with the WTRU_{LDN} 831 and/or WTRU_{PRAS} 832 and the N3TF 833 and/or PRAS 834. An N2 PDU Session Response 816 may be sent from the N3TF 833 and/or PRAS 834 to the AMF_{CPN} 821 through the PDU session 817. At 815, the AMF_{CPN} 821, a SMF_{CPN} 837, the L-UPF 836 and/or the UPF_{CPN} 838 may perform a UE-requested PDU Session Establishment for non-roaming and roaming with local breakout. For example, the UE-requested PDU Session Establishment for non-roaming and roaming with local breakout may include and/or correspond to the Update of the SMF context regarding the PDU session, N4 session modification, IPv6 address configuration and SMF policies modification.

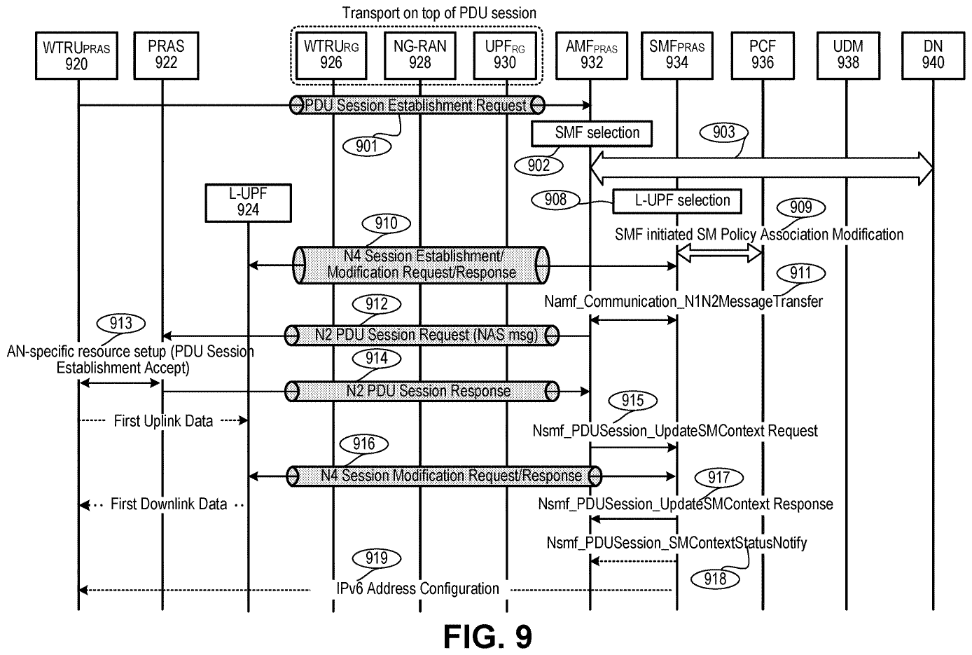

FIG. 9 is a flowchart for an example procedure to set up a PDU session for a WTRU connected to a PRAS 922 using the L-UPF 924. The example procedure provides for a WTRU associated with a PRAS 922 within a CPN to set up a PDU session and for that PDU session to be served by the L-UPF 924 located in the CPN.

The example procedure may assume certain characteristics. The WTRU_{RG} 926 may have previously established a PDU session (e.g., via the NG-RAN 928) with the UPF_{RG} 930. It is assumed that the L-UPF 924 may have already registered to the network using the established PDU session by the WTRU_{RG} 926. The eRG (e.g., WTRU_{RG}, NG-RAN 928, and/or UPF_{RG} 930) may have provided to the network, on its registration message, information about its CPN capabilities, such as the presence of an L-UPF 924 in the CPN and the capability of the WTRU_{RG} 926 to transport signaling messages on its PDU connections. Signaling between the 5GC and the network functions (NFs) in the CPN may be done using the PDU connection established by the WTRU_{RG} 926. AMF and SMF selection may be performed considering the capabilities of the eRG and the CPN.

In the example procedure, at 901, the WTRU_{PRAS} 920, associated with a PRAS 922 located in the CPN, may request the establishment of a PDU session. This may be done through the transmission of a PDU session establishment request message. The PDU session establishment request may be sent to the AMF_{PRAS} 932 using the established PDU session by the WTRU_{RG} 926 (e.g., the previously established PDU session between the WTRU_{RG} 926 and the UPF_{RG} 930). The WTRU_{RG} 926 may receive the PDU session establishment request and forward the PDU session establishment request message via the established PDU session (e.g., of a gateway associated with the CPN). The PRAS 922, in this case, may be connected to the 5G Core through the eRG. The WTRU_{RG} 920 may oversee encapsulating this message and transporting the message via the existing WTRU_{RG} 926 PDU session toward the UPF_{RG} 930. At 902, the AMF managing the PRAS 922 (AMF_{PRAS} 932) (e.g., which may be different from the AMF managing the WTRU_{RG} 926) may perform SMF selection. At 903, in some examples, the AMF_{PRAS} 932, SMF_{PRAS} 934, PCF 936, UDM 938, and/or DN 940 may perform WTRU-requested PDU Session Establishment for non-roaming and roaming with local breakout. The process performed at 903 may include and/or correspond to the creation of PDU session SMF context, retrieval of information form the UDM, PDU session authentication/authorization, and/or PCF selection. For example, the process may be performed at 903 to select and/or register the SMF_{PRAS} 934.

Once the SMF_{PRAS} 934 has been selected and registered, the SMF_{PRAS} 934 may perform UPF selection at 908. In this case, the SMF_{PRAS} 934 may select the L-UPF 924 located in the eRG (e.g., WTRU_{RG}, NG-RAN 928, and/or UPF_{RG} 930) of the CPN. This selection may be performed based on information provided by the WTRU_{PRAS} 920 in the PDU session establishment request message and information on CPN/eRG capabilities.

In the example procedure shown in FIG. 9, the information that the AMF_{PRAS} 932 may use to perform SMF selection may include the elements described herein. The information that the AMF_{PRAS} 932 may use to perform SMF selection may include an indication of L-UPF 924 support in the NAS-Mobility Management (NAS-MM) message that carried the PDU session establishment request message 901 or based on an indication of L-UPF 924 support in an earlier NAS registration request. For example, in the form of an L-UPF 924 indication within the eRG capabilities IE or in a 5GMM capabilities IE.

The information may include a data network name (DNN)/Single Network Slice Selection Assistance Information (S-NSSAI) combination in the NAS-MM message that carried the PDU session establishment request message. For example, the WTRU's subscription information may include service parameters that are associated with the DNN/S-NSSAI combination, and the service parameters may indicate that this DNN/S-NSSAI combination requires the selection of an L-UPF 924.

The information that the AMF_{PRAS} 932 may use to perform SMF selection may include an indication by the WTRU_{RG} 926 on its capabilities to transport signaling from the N3TF or PRAS 922 on its PDU sessions. In the case that the AMF_{PRAS} 932 is informed of such transport, the SMF_{PRAS} 934 may be indicated that the use of L-UPF 924 is preferred.

Lastly, the information that the AMF_{PRAS} 932 may use to perform SMF selection may include information on the locality of the user by providing the DNN what the DNN is connected to, the NSSAI, or information on the public land mobile network (PLMN). The locality of the user may include information related to the user's local environment or close vicinity. The locality of the user may be a position identify of the PRAS instance in the CPN.

The information listed above, as considered by the AMF 932 in SMF selection 902, may be sent by the AMF 932 to the selected SMF_{PRAS} 934. Based on this information, the SMF_{PRAS} 934 may identify the WTRU_{PRAS} 920 as connected to the PRAS 922 in the CPN and select the L-UPF 924 to handle the data traffic of the WTRU_{PRAS} 920.

At 909, the SMF may initiate an SM policy association modification between the SMF and the PCF. The indication of L-UPF 924 support may include contact information for the L-UPF 924 (e.g., an IP Address that may be used to send N4 messages to the L-UPF 924). The contact information for the L-UPF 924 may be stored in the WTRU's subscription information as a service parameter that is associated with the DNN/S-NSSAI combination that may use the L-UPF 924.

The L-UPF 924 may be initially reachable through the PDU session established by the WTRU_{RG}. At 910, an N4 session between the SMF_{PRAS} 934 and the L-UPF 924 through the PDU session of the eRG (e.g., the PDU session previously established between the WTRU_{RG} 926 and the UPF_{RG} 930) may be established. The N4 session establishment/modification request/response may be communicated between the L-UPF 924 and the SMF_{PRAS} 934 using the established PDU session by the WTRU_{RG} 926. The established PDU session may enable the use, for example, of private addressing reachable through the WTRU tunnel, for the N4 endpoint at the L-UPF 924. The example procedure shown in FIG. 9 may include the use of the eRG PDU session to convey the signaling between the WTRU_{PRAS} 920, PRAS 922, L-UPF 924, and the corresponding control entities in the core (e.g., the AMF_{PRAS}, SMF_{PRAS}, etc.). At 911, an SMF initiated SM policy association modification may be communicated between the SMF_{PRAS} 934 and PCF 936. At 912, AMF_{PRAS} 932 may send the N2 PDU session request (NAS msg) to PRAS 922 using the established PDU session by the WTRU_{RG} 926.

At 913, the WTRU_{PRASS} 920 may finish the establishment of the PDU session establishment setup from or to the PRAS 922 via AN-specific resource setup procedure.

At 914, the PRAS 922 may send an N2 PDU session response to the AMF 932 through the L-UPF 924. The PRAS 922 may send an N2 PDU session response to AMF_{PRAS} 932 using the established PDU session by the WTRU_{RG} 926. The PDU session establishment request message may be forwarded to an access and mobility management function (AMF) 932. The L-UPF 924 may receive uplink data from the WTRU_{PRAS} 920.

At 915, the AMF 932 may send an Nsmf_PDUSession_UpdateSMContext Request to the SMF 934 (triggered by the message at 914). At 916, the L-UPF 924 may process an N4 session modification request/response from the SMF 934. N2 PDU Session Response 914 and N4 Session Modification Request/Response 916 may be transported on top of the PDU connection established by WTRU_{RG} 926. The N4 session modification request/response may be communicated between the L-UPF 924 and the SMF_{PRAS} 934 using the established PDU session by the WTRU_{RG} 926.

The L-UPF 924 may receive downlink data and send the downlink data to the WTRU_{PRAS} 920. The downlink data may reach the L-UPF 924 via the PDU session already established by WTRU_{RG} 926 or directly through the local DN towards the L-UPF 924.

At 917, the SMF_{PRAS} 934 may send an Nsmf_PDUSession_UpdateSMContext Response to the AMF_{PRAS} 932. At 918, the SMF 934 may send a Nsmf_PDUSession_SMContextStatusNotify message to the AMF. At 919, the SMF may send an IPV6 Address Configuration to the WTRU_{PRAS} 920. NG-RAN 928 may be the RAN used by WTRU_{RG} to establish the PDU session. UPF 930 may be the UPF used for the PDU session of WTRU_{RG}. PCF 936 may form part of the entities required in the flow (Policy Control Function). UDM 938 may be the Unified Data Management and contains the subscription information. DN 940 may be a data network to connect to.

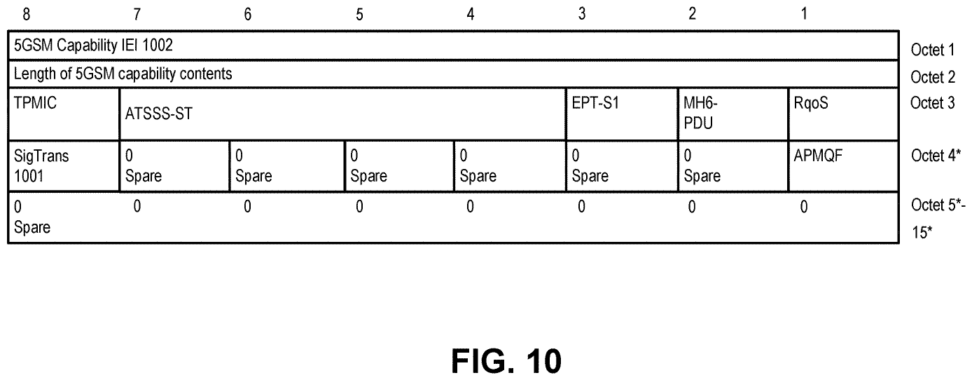

FIG. 10 is a table of examples of extended 5G session management (5GSM) capabilities IE. This table may define extensions to the current non-access stratum (NAS) protocol to request for addresses to be assigned to devices connecting through the PDU session established by another device, e.g., the L-UPF connected through the WTRU_{RG}.

The transport of N2 or N4 signaling through the WTRU_{RG} may use an IPV4 address (e.g., IP-S, IP used for signaling) to be assigned to the N3TF, PRAS, or L-UPF. IP-S may belong to the same network as the IP assigned to the WTRU_{RG} by the SMF or protocol data unit session anchor user plane function (PSA UPF). Accordingly, a mechanism to request extra IPV4 IP addresses from the SMF may be needed.

The 5GSM capabilities IE transmitted within the PDU SESSION ESTABLISHMENT REQUEST message (e.g., NAS protocol) may be modified as an initial step to satisfy this need. This modification may include information indicating the PDU session to be established that may be used to carry signaling from entities behind the WTRU_{RG}.

Octet 2 (Length of 5GSM capability contents) may include the information about the length of the 5GSM capability IEI. RqoS may indicate the 5GSM capability to support reflective QoS. Multi-homed IPV6 PDU session (MH6-PDU) may indicate the 5GSM capability for Multi-homed IPV6 PDU session. Ethernet PDN type in S1 mode (EPT-S1) may indicate WTRU's 5GSM capability for Ethernet PDN type in S1 mode. Supported ATSSS steering functionalities and steering modes (ATSSS-ST) may indicate the modes of operation for ATSSS supported. Transfer of Port Management Information Containers (TPMIC) may indicate the 5GSM capability to support transfer of port management information containers.

As shown in FIG. 10 as octet 4*, bit 8, a signaling transport bit (e.g., a SigTrans bit) may indicate if the PDU session may transport signaling from other nodes located behind the WTRU_{RG} initiating the PDU session.

Specifically, the SigTrans 1001 bit may indicate the 5GSM capability 1002 to support the transport of signaling from nodes accessing the 5GC through the WTRU node requesting the PDU session. For example, if the SigTrans 1001 is set to 0, the PDU session may be intended to transport signaling from other nodes; if the SigTrans 1001 is set to 1, the PDU session may not be intended to transport signaling from other nodes.

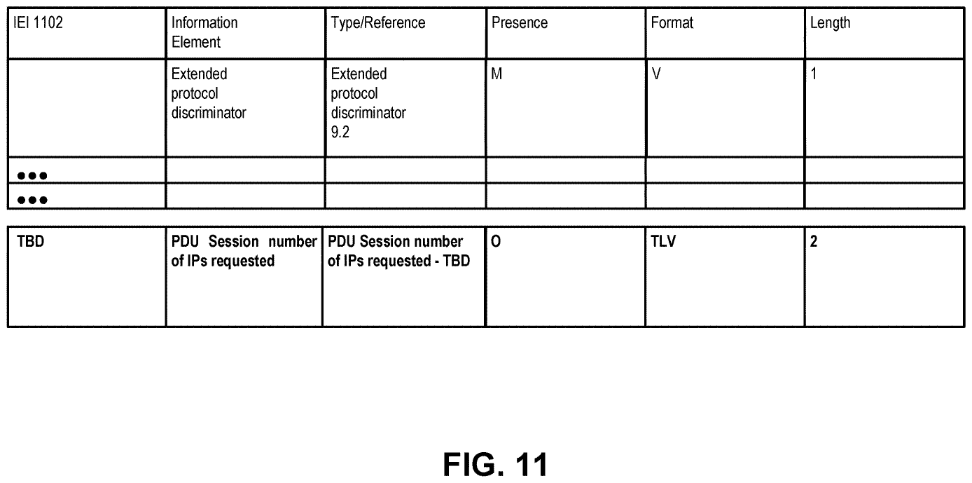

In addition to indicating the intended use of the PDU session, the WTRU may inform the SMF of the need to allocate more than one IPV4 address to the WTRU_{RG}. As shown in FIG. 11, an IE 1102 to be carried within the PDU SESSION ESTABLISHMENT REQUEST message (e.g., NAS protocol) may be defined to incorporate this information.

The PDU Session number of IPs requested as defined within an IE to be carried within the PDU SESSION ESTABLISHMENT REQUEST message may be defined, for example, as follows:

| | | | | | | | |
|---|---|---|---|---|---|---|---|
| 8 | 7 | 6 | 5 | 4 | 3 | 2 | 1 |

| PDU address IEI | | | | | | Octet 1 |
|---|---|---|---|---|---|---|
| NATav | 0 | 0 | 0 | 0 | Number of IP Addresses | Octet 2 |
| | Spare | Spare | Spare | Spare | requested | |

The NATav bit may indicate if the WTRU is able to do network address translation (NAT) for the signaling of other nodes using the PDU session for transporting signaling. For example, if the NATav bit is set to 0, NAT for signaling may not be supported; if the NATav bit is set to 1, NAT for signaling may be supported.

The Number of IP Addresses requested may be a 3 bits long field indicating the number of IPs requested. The length of this field may be adjusted up to 7 bits, depending on the needs.

The SMF, upon allocating IP addresses, may respond to this query through a PDU SESSION ESTABLISHMENT ACCEPT message (e.g., NAS protocol), including a modified PDU address IE as follows:

| | | | | | | | |
|---|---|---|---|---|---|---|---|
| 8 | 7 | 6 | 5 | 4 | 3 | 2 | 1 |

| PDU address IEI | | | | Octet 1 |
|---|---|---|---|---|
| Length of PDU address contents | | | | Octet 2 |
| uNAT | Number of IPv4s | SI6LLA | PDU session | Octet 3 |
| | provided | | type value | |

| | |
|---|---|
| PDU address information | Octet 4 |
| | Octet n |
| SMF's IPv6 link local address | Octet |
| | (n + 1)* |
| | Octet |
| | (n + 16)* |

The uNAT bit may indicate to the WTRU originating the PDU SESSION ESTABLISHMENT REQUEST message to use NAT for the transport of signaling of entities using this PDU session behind the WTRU.

The “Number of IPV4s provided” field may indicate the number of IPs provided as a 3 bits number.

If the “Number of IPV4s provided” field is different from 0, the PDU address information may carry a concatenation of IPV4 addresses (e.g., 4 octets each), up to a total of 16 addresses. In this case, the PDU session type may not indicate a value different from IPv4.

In order for N3TF and/or L-UPF to register with the 5GC and to be able to exchange N2 and N4 messages with the corresponding entity at the 5GC, these functions may need to be provided with an IP address, for example, as described above.

In addition to providing each function with an IP address so each function is reachable from the 5GC, NAT at the WTRU_{RG} may be used. Specifically, a mechanism may be provided by which the WTRU_{RG} may use NAT to transport the N4 protocol (e.g., or any other protocol using IP).

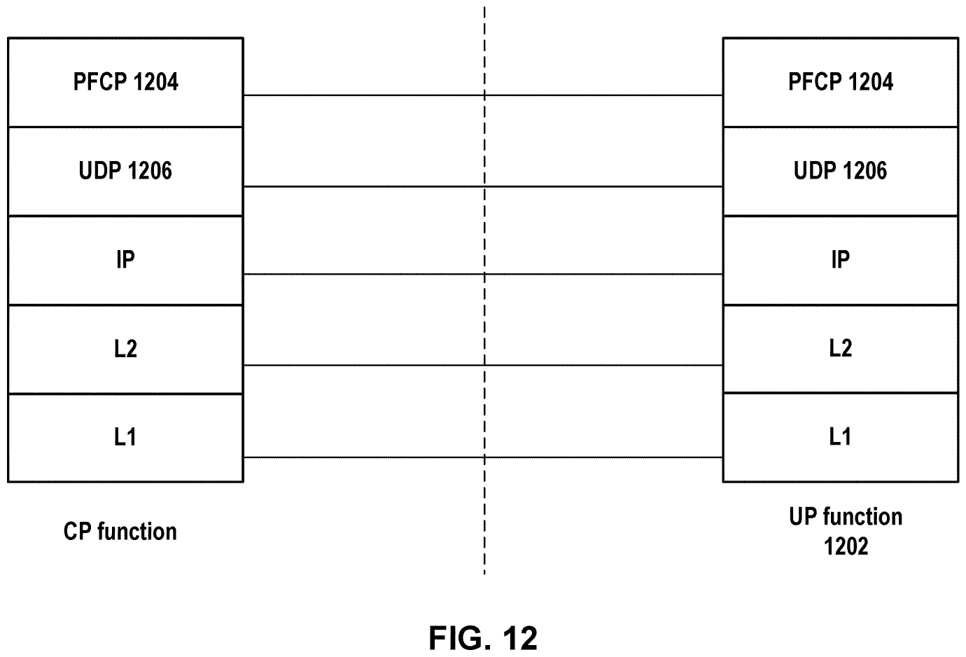

FIG. 12 is a diagram illustrating an example of a control plane protocol stack for N4. The disclosed control plane protocol stack may provide for the transport of the N4 interface toward the L-UPF 1202. As shown in FIG. 12, the N4 interface may use the packet forwarding control protocol (PFCP) 1204 between the SMF (e.g., CP function) and the UP function (UPF). The PFCP 1204 may be transported via UDP 1206 using a reserved port. PFCP may be encapsulated in UDP. The UDP may be encapsulated in IP. The IP may be encapsulated in a generic L2/L1.

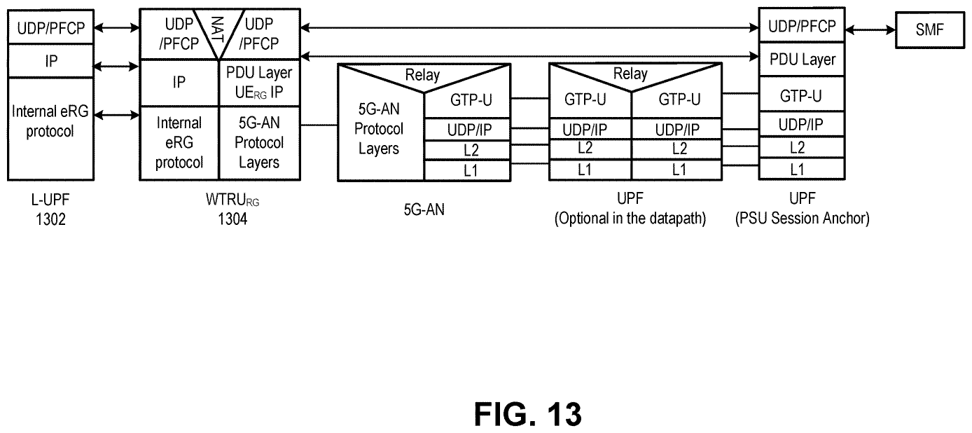

FIG. 13 is a flowchart for an example of N4 transport through a WTRU_{RG} PDU session with NAT. The PFCP message may be generated by the SMF, which uses the PDU session anchor UPF to transmit the PFCP message to the L-UPF 1302. In some examples, the message may be encapsulated in an IP packet, with the destination address set to the WTRU_{RG} IP address for this PDU session and the source IP address set to the SMF one.

The packet may be transported using the PDU session established by WTRU_{RG}. Once the packet reaches WTRU_{RG} 1304, the packet may be processed by a NAT integrated into WTRU_{RG}, which modifies the destination address of the PFCP message (e.g., UR_{RG} IP address) to a CPN address from the eRG address. Ports used by PFCP are reserved so NAT is needed, although in a different setup, network address port translation (NAPT) may be needed.

A similar approach may be used to transport any other signaling on top of the PDU session established by WTRU_{RG}, for example, N2 signaling from the N3TF, which may also use NAT by the WTRU_{RG}.

What is claimed is:

1. A method performed by a first wireless transmit/receive unit (WTRU), the method comprising:
receiving a packet data unit (PDU) session establishment request from a second WTRU within a customer premise network (CPN);
forwarding the PDU session establishment request message via an established PDU session of a gateway associated with the CPN;
receiving, from a session management function (SMF), an indication of a local user plane function (L-UPF) associated with the CPN, wherein the L-UPF is selected based on at least one of:
the PDU session establishment request message, or one or more capabilities associated with the gateway; and
establishing a session between the WTRU and the L-UPF through the established PDU session.

2. The method of claim 1, further comprising:
establishing the PDU session with a user plane function (UPF) associated with a residential gateway (RG).

3. The method of claim 1, wherein control plane data received from the second WTRU is received via an N2 interface that is forwarded via the established PDU session.

4. The method of claim 1, wherein control plane data received from the L-UPF is received via an N4 interface that is forwarded via the established PDU session.

5. The method of claim 1, wherein the L-UPF is selected based on information provided by the second WTRU in the PDU session establishment request message.

6. The method of claim 5, wherein the information provided by the second WTRU comprises an indication of an L-UPF support, or information on a locality of a user.

7. The method of claim 1, wherein the CPN is a network located within a premise via the gateway, and the gateway is an evolved residential gateway (eRG) that is connected to a core network via a mobile access network.

8. The method of claim 1, further comprising:
receiving uplink data via the L-UPF from the second WTRU; and
sending the uplink data to the SMF via the gateway associated with the CPN.

9. The method of claim 1, further comprising: receiving downlink data and sending the downlink data to the second WTRU via the L-UPF.

10. The method of claim 1, wherein the PDU session establishment request message is forwarded to an access and mobility management function (AMF).

11. A first wireless transmit/receive unit (WTRU), comprising:
a processor and memory, wherein the processor and memory are configured to:
receive a packet data unit (PDU) session establishment request from a second WTRU within a customer premise network (CPN);
forward the PDU session establishment request message via an established PDU session of a gateway associated with the CPN;
receive, from a session management function (SMF), an indication of a local user plane function (L-UPF) associated with the CPN, wherein the L-UPF is selected based on at least one of:
the PDU session establishment request message, or one or more capabilities associated with the gateway; and
establish a session between the WTRU and the L-UPF through the established PDU session.

12. The first WTRU of claim 11, wherein the processor and memory are further configured to:
establish the PDU session with a user plane function (UPF) associated with a residential gateway (RG).

13. The first WTRU of claim 11, wherein control plane data received from the second WTRU is received via an N2 interface that is forwarded via the established PDU session.

14. The first WTRU of claim 11, wherein control plane data received from the L-UPF is received via an N4 interface is forwarded via the established PDU session.

15. The first WTRU of claim 11, wherein the L-UPF is selected based on information provided by the second WTRU in the PDU session establishment request message.

16. The first WTRU of claim 15, wherein the information provided by the second WTRU comprises an indication of an L-UPF support, or information on a locality of a user.

17. The first WTRU of claim 11, wherein the CPN is a network located within a premise via the gateway, and the gateway is an evolved residential gateway (eRG) that is connected to a core network via a mobile access network.

18. The first WTRU of claim 11, wherein the processor and memory are further configured to:
receive uplink data via the L-UPF from the second WTRU; and
send the uplink data to the SMF via the gateway associated with the CPN.

19. The first WTRU of claim 11, wherein the processor and memory are further configured to:
receive downlink data and send the downlink data to the second WTRU via the L-UPF.

20. The first WTRU of claim 11, wherein the PDU session establishment request message is forwarded to an access and mobility management function (AMF).
